(19) United States
(12) Patent Application Publication
(10) Pub. No.: US 2026/0311245 A1
(43) Pub. Date: Oct. 8, 2026

(54) Vehicle Auction Software Application Device

(71) Applicant: Javier Jaimes, Wenatchee, WA (US)

(72) Inventor: Javier Jaimes, Wenatchee, WA (US)

(21) Appl. No.: 19/295,800

(22) Filed: Aug. 11, 2025

Related U.S. Application Data
(60) Provisional application No. 63/782,849, filed on Apr. 3, 2025.

(51) Int. Cl. G06Q 30/08; G06Q 50/40

(52) U.S. Cl. CPC G06Q 30/08; G06Q 50/40

(57) ABSTRACT

A vehicle auction software application device is disclosed, which is a unique software application accessible on a smartphone, tablet, laptop, or a desktop computer. The software application facilitates the safe and efficient transfer of vehicles from an auction yard to a transport vehicle. The software application comprises an easy-to-use interface which allows users to track purchased vehicles on an auction lot, let a buyer know when a vehicle is ready for pick up, find and book a transporter, and automatically send gate passes to authorized parties. Further, the software application will link information between auction lots, transport companies, towing providers, dealers, etc.

### CROSS REFERENCE TO RELATED APPLICATION

The present application claims priority to, and the benefit of, U.S. Provisional Application No. 63/782,849, which was filed on Apr. 3, 2025, and is incorporated herein by reference in its entirety.

### FIELD OF THE INVENTION

The present invention relates generally to the field of vehicle auction application devices. More specifically, the present invention relates to a software application that makes transfer of a sold vehicle from the auction yard to the transporter and ultimately the buyer both simple and efficient. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in vehicle auction software application devices. Generally, auction dealers often struggle to find a vehicle in an auction yard once it has been sold and sometimes struggle arranging for efficient transportation of the sold vehicle to the buyer. This can be time-consuming, inefficient, and frustrating. Further, the longer the sold vehicle sits awaiting transport, the higher the risk for theft or other damage.

Accordingly, there is a demand for an improved vehicle auction software application device that makes transfer of a sold vehicle from the auction yard to the transporter and buyer both simple and efficient. More particularly, there is a demand for a vehicle auction software application device that links information between auction lots, transport companies, towing providers, dealers, etc.

Therefore, there exists a long-felt need in the art for a vehicle auction software application device that provides users with a software application designed to facilitate the safe and efficient transfer of vehicles from an auction yard to a transport vehicle. There is also a long-felt need in the art for a vehicle auction software application device that features an easy-to-use interface to allow users to track purchased vehicles on an auction lot. Further, there is a long-felt need in the art for a vehicle auction software application device that also lets a buyer know when a vehicle is ready for pick up. Moreover, there is a long-felt need in the art for a device that includes the ability to book a transporter and automatically send gate passes to authorized parties, as needed. Further, there is a long-felt need in the art for a vehicle auction software application device that links information between auction lots, transport companies, towing providers, dealers, etc. Finally, there is a long-felt need in the art for a vehicle auction software application device that, when in operation, is based on geographic proximity, thereby prioritizing users and vendors closest to the requested service.

The subject matter disclosed and claimed herein, in one embodiment thereof, comprises a vehicle auction software application device. The device is a unique software application accessible on a smartphone, tablet, laptop, or a desktop computer. The software application facilitates the safe and efficient transfer of vehicles from an auction yard to a transport vehicle. The software application comprises an easy-to-use interface which allows users to track purchased vehicles on an auction lot, let a buyer know when a vehicle is ready for pick up, find and book a transporter, and automatically send gate passes to authorized parties. Further, the software application will link information between auction lots, transport companies, towing providers, dealers, etc. The software application, when in operation, is based on geographic proximity, thereby prioritizing users and vendors closest to the requested service.

In this manner, the vehicle auction software application device of the present invention accomplishes all of the foregoing objectives and provides users with a device that facilitates transfer of vehicles from an auction yard. The device is a software application which links information between auction lots, transport companies, and users. The device can be accessed through a smartphone, tablet, or a desktop computer.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle auction software application device. The device is a unique software application accessible on a smartphone, tablet, laptop, or a desktop computer. The software application facilitates the safe and efficient transfer of vehicles from an auction yard to a transport vehicle. The software application comprises an easy-to-use interface which allows users to track purchased vehicles on an auction lot, and other functions.

In one embodiment, the vehicle auction software application device utilizes a smartphone, a tablet, a laptop or a desktop computer, etc., or any other suitable electronic device that has the required operating and memory parameters to support the software application of the present invention.

In one embodiment, the software application comprises an easy-to-use interface. A user would create an account and then log into the software application. The user can then utilize the software application to scroll through a list of transporters to find and book a transporter. Users then apply filters when searching for specific transporters within specific geographic parameters and timelines. Users can also identify a transporter which matches the parameters of the filter and automatically sends gate passes to authorized parties. Then, users can utilize the software application to track purchased vehicles on an auction lot all the way to the transporter and then ultimately to the buyer (i.e., user). The software application can then be utilized to let a buyer/user know when a vehicle is ready for pick up from the transporter.

In one embodiment, the software application provides a secure website and/or smart phone app access by users and/or vendors. In addition, the device of the present invention may also include: a web server and Cloud database of vendor and vehicle identification and location data connectable to the mobile smartphone or portable tablet or computer device. Thus, the software application allows for linking information between vehicle auction lots, transport companies, towing providers, dealers, etc., via the web server and Cloud database.

In one embodiment of the invention, the vendor and vehicle identification and location data and data management software are maintained on a Microsoft Cloud server in a typical fashion, or other cloud server, such as the Adobe, Apple or Amazon cloud server, etc. A secure cloud server is used for the protection and security of vendor and vehicle identification and location data and user information data stored on the cloud server. Thus, vendor and vehicle identification and location data and user information data are sent to the cloud server and collected. Conveniently, the data is stored and managed with a data management software or program to manage the collected vendor and vehicle identification and location data, and user data. Accordingly, the data management software or program collects the information and links the information for use in the software application. Further, the linked information includes but is not limited to, vendor and vehicle identification and location data, auction lot information data, transport company data, towing provider data, dealer and user data, etc.

In one embodiment, the vehicle auction software application device comprises a GPS system to track user and vendor locations in real-time to determine and prioritize users and vendors closest to the requested service.

Typically, a cellular wireless data network embedded in the computer, tablet or smartphone, etc., transmits both vendor and vehicle identification and location data and GPS coordinates at incremental times to a user. Such vendor and vehicle identification and location data can be processed by the user via a Cloud data management server. Generally, GPS is embedded in the computer or tablet, etc., as it is in a smartphone. On the smart device, a digital mapping service, such as Microsoft Bing mapping or other competitive mapping services overlays the vehicle locations on the navigation mapping for visual tracking of the vehicle location as it proceeds on its route in real-time. Thus, at any given time, the location of the vehicle can be determined.

Mobility is a key feature of the present invention. It permits flexibility. For example, if a user is tracking a purchased auction vehicle, the user can track the auction vehicle in real time, by identifying its immediate location on a digital map.

The present invention offers a solution to tracking purchased vehicles from an auction yard to a transport vehicle and ultimately to the buyer (i.e., user). Thus, a given vehicle can be tracked as it's being transported from the auction yard to the buyer. Specifically, GPS coordinates are used to locate the vehicle via the GPS embedded in the smartphone, computer, or tablet, etc. A software application for users and/or vendors, which is accessed via a smartphone, tablet or computer, etc., then maps and displays vehicles' location in real-time. Further, optional text message notifications can be utilized to notify users and/or vendors of vehicles being transported.

Additionally, the software application utilizes the GPS system to identify vendor and vehicle location, which can allow for prioritizing users and vendors closest to the requested service. Thus, in operation the software application is based on geographic proximity.

In yet another embodiment, the vehicle auction software application device comprises a plurality of indicia.

In yet another embodiment, a method of facilitating transfer of vehicles from an auction yard using a software application is disclosed. The method includes the steps of providing a vehicle auction software application device comprising a software application that facilitates transfer of vehicles from auction yards. The method also comprises accessing the software application. Further, the method comprises utilizing an interface to track purchased auction vehicles, know when the vehicle is ready for pickup, find a transporter, and send gate passes. Finally, the method comprises prioritizing users and vendors based on geographic proximity.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a perspective view of one embodiment of the vehicle auction software application device of the present invention showing the login page in accordance with the disclosed architecture;

FIG. 1B illustrates a perspective view of one embodiment of the vehicle auction software application device of the present invention showing the account information page in accordance with the disclosed architecture;

FIG. 2 illustrates a perspective view of one embodiment of the vehicle auction software application device of the present invention showing the transport listing page in accordance with the disclosed architecture;

FIG. 3 illustrates a perspective view of one embodiment of the vehicle auction software application device of the present invention showing the filters that can be used when searching in accordance with the disclosed architecture;

FIG. 4A and B illustrate a perspective view of one embodiment of the vehicle auction software application device of the present invention showing the jobs assigned and the gate passes in accordance with the disclosed architecture;

FIG. 5A-C illustrate a perspective view of one embodiment of the vehicle auction software application device of the present invention showing the application pages;

FIG. 6 illustrates a flowchart showing the method of facilitating transfer of vehicles from an auction yard using a software application in accordance with the disclosed architecture;

FIG. 7 is a schematic diagram illustrating one embodiment of the software application for facilitating transfer of vehicles from an auction yard of the present invention in accordance with the disclosed architecture; and

FIG. 8 illustrates an exemplary user device that is used for installing the software application for facilitating transfer of vehicles from an auction yard of the present invention for communication with a server system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a vehicle auction software application device that provides users with a software application designed to facilitate the safe and efficient transfer of vehicles from an auction yard to a transport vehicle. There is also a long-felt need in the art for a vehicle auction software application device that features an easy-to-use interface to allow users to track purchased vehicles on an auction lot. Further, there is a long-felt need in the art for a vehicle auction software application device that also lets a buyer know when a vehicle is ready for pick up. Moreover, there is a long-felt need in the art for a device that includes the ability to book a transporter and automatically send gate passes to authorized parties, as needed. Further, there is a long-felt need in the art for a vehicle auction software application device that links information between auction lots, transport companies, towing providers, dealers, etc. Finally, there is a long-felt need in the art for a vehicle auction software application device that, when in operation, is based on geographic proximity, thereby prioritizing users and vendors closest to the requested service.

The present invention, in one exemplary embodiment, is a novel vehicle auction software application device. The device is a unique software application accessible on a smartphone, tablet, laptop, or a desktop computer. The software application facilitates the safe and efficient transfer of vehicles from an auction yard to a transport vehicle. The software application comprises an easy-to-use interface which allows users to track purchased vehicles on an auction lot, let a buyer know when a vehicle is ready for pick up, find and book a transporter, and automatically send gate passes to authorized parties. Further, the software application will link information between auction lots, transport companies, towing providers, dealers, etc. The software application, when in operation, is based on geographic proximity, thereby prioritizing users and vendors closest to the requested service. The present invention also includes a novel method of facilitating transfer of vehicles from an auction yard using a software application. The method includes the steps of providing a vehicle auction software application device comprising a software application that facilitates transfer of vehicles from auction yards. The method also comprises accessing the software application. Further, the method comprises utilizing an interface to track purchased auction vehicles, know when the vehicle is ready for pickup, find a transporter, and send gate passes. Finally, the method comprises prioritizing users and vendors based on geographic proximity.

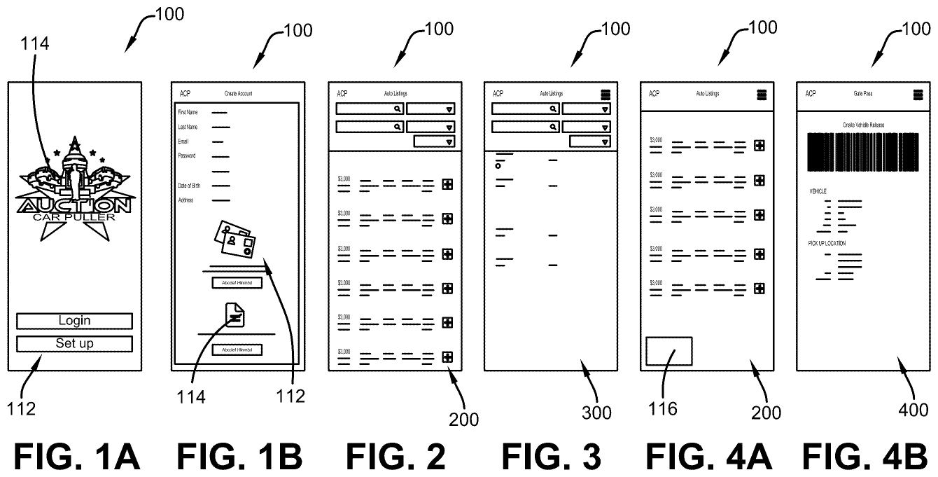

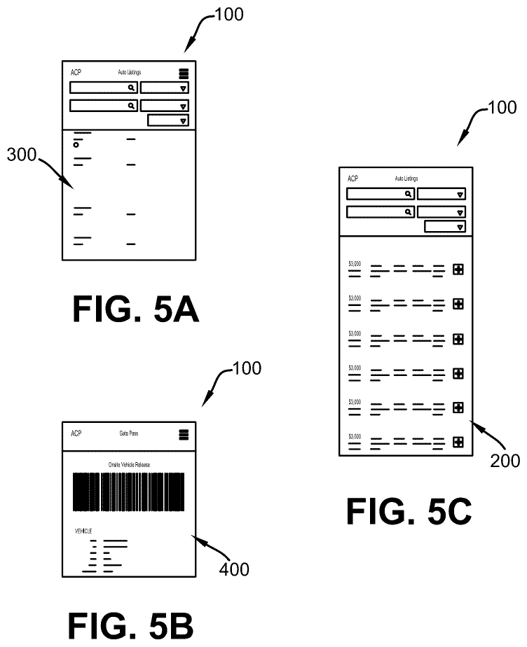

Referring initially to the drawings, FIGS. 1-5 illustrate a perspective view of one embodiment of the vehicle auction software application device 100 of the present invention. In the present embodiment, the vehicle auction software application device 100 is a software application that allows for the efficient transport of auction vehicles. Specifically, the vehicle auction software application device 100 is a unique software application accessible on a smartphone, tablet, laptop, or a desktop computer (i.e., user device 102). The software application 100 facilitates the safe and efficient transfer of vehicles from an auction yard to a transport vehicle. The software application 100 comprises an easy-to-use interface and links information between auction lots, transport companies, towing providers, dealers, etc.

Generally, the vehicle auction software application device 100 utilizes a smartphone, a tablet, a laptop or a desktop computer, etc., (i.e., user device 102), or any other suitable electronic device that has the required operating and memory parameters to support the software application 100 of the present invention.

As shown in FIGS. 1A-B, the software application 100 comprises an easy-to-use interface 112. A user would create an account and then log into the software application 100. Specifically, users would enter, among other information, their name, email address, date of birth, etc., then would create a password to complete registration of their account.

As shown in FIGS. 2-3, users can then utilize the software application 100 to scroll through a list 200 of transporters to find and book a transporter. Specifically, users can apply filters 300 when searching for specific transporters, such as transporters within specific geographic parameters and timelines, etc.

As shown in FIGS. 4A-B and 5A-C, users can also identify a transporter which matches the parameters of the filter 300. Once a specific transporter is identified, the software application 100 can then automatically send gate passes 400 to authorized parties for pickup of the auction vehicle(s). After pickup has occurred, users can utilize the software application 100 to track purchased vehicles on an auction lot all the way to the transporter and then ultimately to the buyer (i.e., user). The software application 100 can then be utilized to let a buyer/user know when a vehicle is ready for pick up from the transporter, etc.

Generally, the software application 100 provides a secure website and/or smart phone app access by users and/or vendors. In addition, the device 100 of the present invention may also include: a web server 108 and Cloud database 110 of vendor and vehicle identification and location data connectable to the mobile smartphone or portable tablet or computer device 102. Thus, the software application 100 allows for linking information between vehicle auction lots, transport companies, towing providers, dealers, etc., via the web server 108 and Cloud database 110.

In one embodiment of the invention, the vendor and vehicle identification and location data and data management software are maintained on a Microsoft Cloud server in a typical fashion, or other cloud server, such as the Adobe, Apple or Amazon cloud server, etc. A secure cloud server is used for the protection and security of vendor and vehicle identification and location data and user information data stored on the cloud server. Thus, vendor and vehicle identification and location data and user information data are sent to the cloud server and collected. Conveniently, the data is stored and managed with a data management software or program to manage the collected vendor and vehicle identification and location data, and user data. Accordingly, the data management software or program collects the information and links the information for use in the software application. Further, the linked information includes but is not limited to, vendor and vehicle identification and location data, auction lot information data, transport company data, towing provider data, dealer and user data, etc.

Further, the vehicle auction software application device 100 comprises a GPS system 116 to track user and vendor locations in real-time to determine and prioritize users and vendors closest to the requested service. The Global Positioning System (GPS) is a satellite-based navigation system made up of a network of 24 satellites placed into orbit by the U.S. Department of Defense. GPS was originally intended for military applications, but in the 1980s, the government made the system available for civilian use. The GPS system 116 is embedded in many computers, tablets and smartphones, etc. 102, and is used in navigation applications in these devices 102 as well as vehicles and hunter or outdoor tracking devices.

Typically, a cellular wireless data network 106 embedded in the computer, tablet or smartphone, etc., (i.e., user device 102), transmits both vendor and vehicle identification and location data and GPS coordinates at incremental times to a user. Such vendor and vehicle identification and location data can be processed by the user via a Cloud data management server. Generally, GPS is embedded in the computer or tablet, etc., as it is in a smartphone 102. On the smart device, a digital mapping service, such as Microsoft Bing mapping or other competitive mapping services overlays the vehicle locations on the navigation mapping for visual tracking of the vehicle location as it proceeds on its route in real-time. Thus, at any given time, the location of the vehicle can be determined.

Accordingly, mobility is a key feature of the present invention. It permits flexibility. For example, if a user is tracking a purchased auction vehicle, the user can track the auction vehicle in real time, by identifying its immediate location on a digital map.

The present invention offers a solution to tracking purchased vehicles from an auction yard to a transport vehicle and ultimately to the buyer (i.e., user). Thus, a given vehicle can be tracked as it's being transported from the auction yard to the buyer. Specifically, GPS coordinates are used to locate the vehicle via the GPS embedded in the smartphone, computer, or tablet, etc. A software application 100 for users and/or vendors, which is accessed via a smartphone, tablet or computer, etc., (i.e., user device 102), then maps and displays vehicles' location in real-time. Further, optional text message notifications can be utilized to notify users and/or vendors of vehicles being transported.

Additionally, the software application 100 utilizes the GPS system 116 to identify vendor and vehicle location, which can allow for prioritizing users and vendors closest to the requested service. Thus, in operation the software application 100 is based on geographic proximity.

In yet another embodiment, the vehicle auction software application device 100 comprises a plurality of indicia 114. Specifically, the software application of the device 100 may include advertising, a trademark, or other letters, designs, or characters, printed, painted, stamped, or integrated into the software application, or any other indicia 114 as is known in the art. Specifically, any suitable indicia 114 as is known in the art can be included, such as but not limited to, patterns, logos, emblems, images, symbols, designs, letters, words, characters, animals, advertisements, brands, etc., that may or may not be vehicle, auction, or brand related.

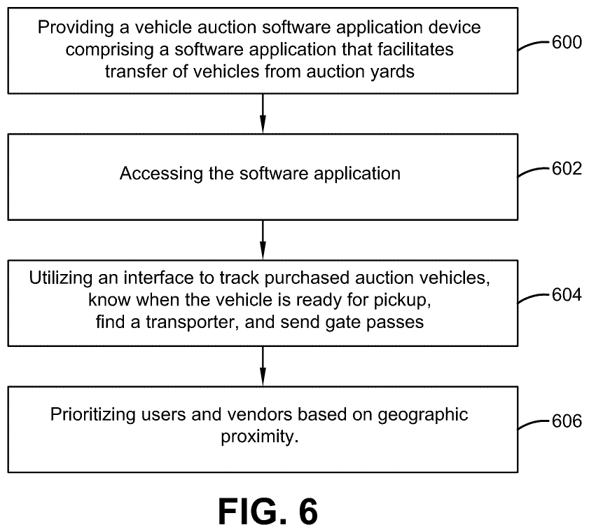

FIG. 6 illustrates a flowchart of the method of facilitating transfer of vehicles from an auction yard using a software application. The method includes the steps of at 600, providing a vehicle auction software application device comprising a software application that facilitates transfer of vehicles from auction yards. The method also comprises at 602, accessing the software application. Further, the method comprises at 604, utilizing an interface to track purchased auction vehicles, know when the vehicle is ready for pickup, find a transporter, and send gate passes. Finally, the method comprises at 606, prioritizing users and vendors based on geographic proximity.

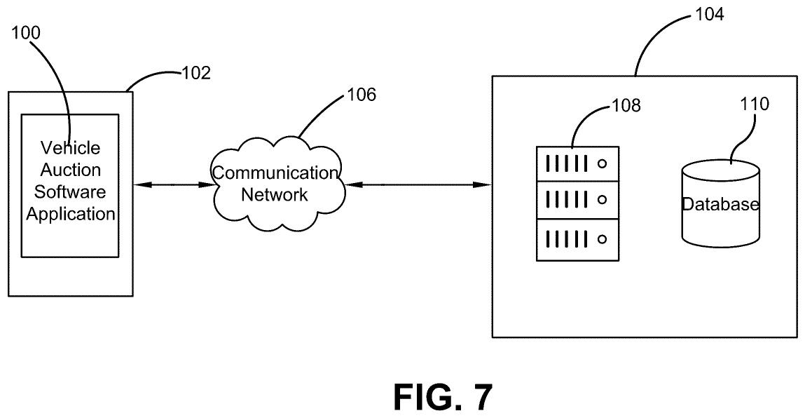

FIG. 7 is a schematic diagram illustrating one embodiment of the vehicle auction software application 100 of the present invention. The software application 100 has a client-server architecture wherein a user accesses the software application 100 installed on a user device 102. The software application 100 also comprises a server system 104 and the user device 102 is communicatively coupled to the server system 104 via a communication network 106, such as the Internet. The user device 102 is capable of facilitating a user to input data, receive data, and/or transmit data within the software application 100. It will be apparent to a user of ordinary skill in the art that the user may be any personnel using the software application 100, without deviating from the scope of the disclosure. Examples of the user device 102 may include, but are not limited to, a desktop, a notebook, a laptop, a handheld computer, a touch sensitive device, a tablet, a computing device, a smart-phone, and/or a smart watch, etc., or any other suitable device as is known in the art.

The server system 104 is a network of computers, a software framework, or a combination thereof, that may provide a generalized approach to creating the server implementation. More specifically, the server system 104 includes an application server 108 and one or more associated databases 110. The application server 108 and the databases 110 can be integrated as a single unit or can be coupled to each other through a network. Examples of the application server 108 may include, but are not limited to, personal computers, laptops, mini-computers, mainframe computers, any non-transient and tangible machine that can execute a machine-readable code, cloud-based servers, distributed server networks, or a network of computer systems, etc. The application server 108 can be realized through various web-based technologies such as, but not limited to, a Java web-framework, a . NET framework, a personal home page (PHP) framework, or any web-application framework, etc. The server system 104 can be maintained by a storage facility management authority or a third-party entity that facilitates service enablement and resource allocation operations of the software application 100.

The application server 108 is configured to have the logic, instructions, circuitry, interfaces, and/or codes for executing various operations required for communication between the server 108 and the user device 102 and also between the databases 110 and the server 108. The databases 110 are configured to store therein, data associated with users' account information from the software application 100, as well as vendor and vehicle identification and location data. In some embodiments, a set of centralized or distributed network of peripheral memory devices may be interfaced with the server 104, as an example, on a cloud server.

The communication network 106 may include suitable logic, circuitry, and interfaces that may be configured to provide a plurality of network ports and a plurality of communication channels for transmission and reception of data related to operations of various entities (such as the user device 102 and the server system 104) of the software application 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 106 may be associated with an application layer for implementation of communication protocols based on one or more communication requests from the user device 102 and the server system 104. The communication data may be transmitted or received via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel or a plurality of communication channels in the communication network 106. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

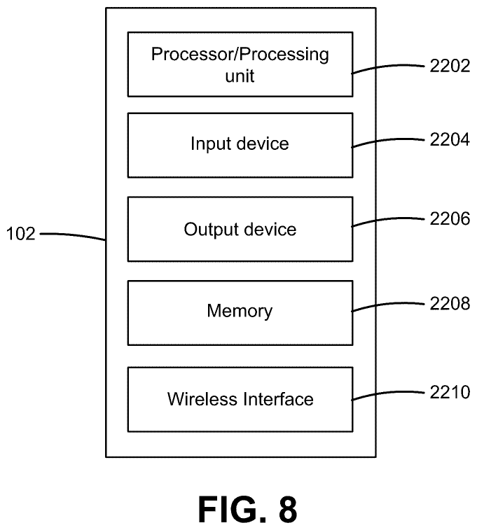

FIG. 8 illustrates an exemplary user device 102 that is used for installing the vehicle auction software application 100 of the present invention. The processing unit 2202 may include suitable logic, instructions, circuitry, interfaces, and/or codes for executing various operations, such as the operations associated with the user device 102, etc. The processing unit 2202 may be configured to control one or more operations executed by the user device 102 in response to the input received at the user device 102 from the user. The processor 2202 executes the computer readable instructions stored in the software application. Examples of the processing unit 2202 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), etc. Embodiments of the present disclosure are intended to include or otherwise cover any type of processing unit 2202 including known, related art, and/or later developed processing units. The user device 102 can further include one or more computer executable applications configured to be executed by the processing unit 2202. The one or more computer executable applications may include suitable logic, instructions, and/or codes for executing various operations. The one or more computer executable applications may be stored in the memory 2208. The one or more computer executable applications includes the software application 100.

The user device 102 comprises input device(s) 2204, such as a touch input device, a voice input device, etc., for entering data and information. Preferably, the touch interface of the user device 102 is used as the input and various buttons/tabs shown on the software application are pressed or clicked by the user.

Electronic user device 102 also comprises a memory 2208 used for storing programs (sequences of instructions) or data (i.e., program state information) on a temporary or permanent basis for use in the computer system. Memory 2208 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 2202, in combination with one or more of memory 2208, input device(s) 2204, and output device(s) 2206 is utilized to allow users to execute instructions on the application 100. The connection to a network is provided by wireless interface 2210.

The wireless interface 2210 enables the user device 102 to communicate with the server 104 and other components of the software application 100 over the communication network 106, according to embodiments of the present disclosure. Examples of the communication interface 2210 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit, etc. It will be apparent to a user of ordinary skill in the art that the communication interface 2210 may include any device and/or apparatus capable of providing wireless or wired communications between the user device 102 and the server 104.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different users may refer to the same feature or component by different names. This document does not intend to distinguish between components or features that differ in name but not structure or function. As used herein, “vehicle auction software application device”, “vehicle auction device”, “software application device”, and “device” are interchangeable and refer to the vehicle auction software application device 100 of the present invention.

Notwithstanding the foregoing, the vehicle auction software application device 100 of the present invention can be of any suitable size and configuration as is known in the art without affecting the overall concept of the invention, provided that it accomplishes the above-stated objectives. One of ordinary skill in the art will appreciate that the vehicle auction software application device 100, as shown in FIGS. 1-8 is for illustrative purposes only, and that many other sizes and shapes of the vehicle auction software application device 100 are well within the scope of the present disclosure. Although the dimensions of the vehicle auction software application device 100 are important design parameters for user convenience, the vehicle auction software application device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle auction software application device that facilitates efficient transfer of auction
vehicles, the vehicle auction software application device comprising:
a software application;
wherein the software application is accessible on a smart device; and
further wherein a user utilizes the software application to track purchased vehicles on an auction lot.

2. The vehicle auction software application device of claim 1, wherein the smart device is a smartphone, tablet, laptop, or a desktop computer.

3. The vehicle auction software application device of claim 2, wherein the software application allows a user to create a secure account and login.

4. The vehicle auction software application device of claim 3, wherein the software application allows a user to scroll through a list of transporters to find and book a transporter.

5. The vehicle auction software application device of claim 4, wherein the software application allows a user to apply filters when searching for specific transporters, such as geographic parameters and timelines.

6. The vehicle auction software application device of claim 5, wherein the software application allows users to identify a transporter which matches parameters of filter and then automatically sends gate passes to authorized parties for pickup of the auction vehicle.

7. The vehicle auction software application device of claim 6, wherein the software application allows users to track purchased vehicles on an auction lot all the way to the transporter and then ultimately to the user.

8. The vehicle auction software application device of claim 7, wherein the software application provides secure website or smart phone application access by users and vendors for vehicle and transport data.

9. The vehicle auction software application device of claim 8 further comprising a web server and a Cloud database of vendor and vehicle identification and location data connectable to the smart device.

10. The vehicle auction software application device of claim 9, wherein vendor and vehicle identification and location data is stored and managed with a data management software or program.

11. The vehicle auction software application device of claim 10, wherein the vehicle auction software application device comprises a GPS system to track user and vendor locations in real-time to determine and prioritize users and vendors closest to a requested service.

12. The vehicle auction software application device of claim 11, wherein GPS coordinates are used to locate the auction vehicle via the GPS system embedded in the smart device, wherein the software application then maps and displays vehicles' location in real-time, allowing a user to track the vehicle location as it proceeds on its route in real-time.

13. A vehicle auction software application device that facilitates efficient transfer of auction vehicles, the vehicle auction software application device comprising:
a software application;
wherein the software application is accessible on a smart device;
wherein the software application allows a user to create a secure account and login;
wherein the software application allows a user to scroll through a list of transporters to find and book a transporter;
wherein the software application allows a user to apply filters when searching for specific transporters, such as geographic parameters and timelines;
wherein the vehicle auction software application device comprises a GPS system to track user and vendor locations in real-time to determine and prioritize users and vendors closest to a requested service;
wherein GPS coordinates are used to locate the auction vehicle via the GPS system embedded in the smart device, wherein the software application then maps and displays vehicles' location in real-time, allowing a user to track the vehicle location as it proceeds on its route in real-time; and
further wherein a user utilizes the software application to track purchased vehicles on an auction lot.

14. The vehicle auction software application device of claim 13, wherein the smart device is a smartphone, tablet, laptop, or a desktop computer.

15. The vehicle auction software application device of claim 13, wherein the software application provides secure website or smart phone application access by users and vendors for vehicle and transport data.

16. The vehicle auction software application device of claim 15 further comprising a web server and a Cloud database of vendor and vehicle identification and location data connectable to the smart device.

17. The vehicle auction software application device of claim 16, wherein vendor and vehicle identification and location data is stored and managed with a data management software or program.

18. The vehicle auction software application device of claim 13, wherein the software application allows users to identify a transporter which matches parameters of filter and then automatically sends gate passes to authorized parties for pickup of the auction vehicle.

19. The vehicle auction software application device of claim 13 further comprising a plurality of indicia.

20. A method of facilitating transfer of vehicles from an auction yard using a software application, the method comprising the following steps:
providing a vehicle auction software application device comprising a software application that facilitates transfer of vehicles from auction yards;
accessing the software application;
utilizing an interface to track purchased auction vehicles, know when the vehicle is ready for pickup, find a transporter, and send gate passes; and
prioritizing users and vendors based on geographic proximity.
